(19) United States
(12) Patent Application Publication
(10) Pub. No.: US 2016/0323715 A1
(43) Pub. Date: Nov. 3, 2016

(54) System and Method for Data Packet Scheduling and Delivery

(71) Applicant: Huawei Technologies Co., Ltd., Shenzhen (CN)

(72) Inventors: Philippe Leroux, Ottawa (CA); Nimal Gamini Senarath, Ottawa (CA); Alex Stephenne, Stittsville (CA)

(21) Appl. No.: 14/701,293

(22) Filed: Apr. 30, 2015

(51) Int. Cl. H04W 4/04; H04W 72/12; H04W 4/02

(52) U.S. Cl. CPC H04W 4/04; H04W 4/028; H04W 72/12

(57) ABSTRACT

A method for sending data packets to mobile devices includes generating time-location information for a first mobile device in accordance with mobility information for the first mobile device and other mobility-related information, wherein the time-location information comprises predictions of when coverage areas of a plurality of transceiver devices operatively coupled to the communications device cover the first mobile device, wherein the communication device serves the first mobile device, selecting a first transceiver device from the plurality of transceiver devices in accordance with the time-location information and a first delivery time associated with a first data packet, and sending the first data packet to the first transceiver device in accordance with the first delivery time, wherein the first data packet is configured to prompt the first transceiver device to transmit the first data packet to the first mobile device.

### TECHNICAL FIELD

The present disclosure relates generally to digital communications, and more particularly to a system and method for data packet scheduling and delivery.

### BACKGROUND

Generally, high-speed traffic is very predictable. As an example, a vehicle on a high-speed highway will typically maintain a relatively constant speed and/or direction on the highway. Similarly, a train will usually maintain a constant speed on the railroad track. Exceptions to the rule may include delays caused by accidents, heavy traffic, and the like.

Network traffic related to vehicles may be heavy. As an illustrative example, on a 500 meter segment of a high-speed highway, there may be approximately 50 cars, which may mean hundreds of active connections (e.g., users watching videos, navigation, real-time conferencing, and the like). It is predicted that in the future, with autonomous vehicles and smart highways, the connection density may increase dramatically.

Therefore, there is a need to support connections, e.g., scheduling and delivering packets, for high-speed traffic.

### SUMMARY OF THE DISCLOSURE

Example embodiments of the present disclosure which provide a system and method for packet scheduling and delivery.

In accordance with an example embodiment of the present disclosure, a method for sending data packets to mobile devices is provided. The method includes generating, by a communications device, time-location information for a first mobile device in accordance with mobility information for the first mobile device and other mobility-related information, wherein the time-location information comprises predictions of when coverage areas of a plurality of transceiver devices operatively coupled to the communications device cover the first mobile device, wherein the communication device serves the first mobile device, and selecting, by the communications device, a first transceiver device from the plurality of transceiver devices in accordance with the time-location information and a first delivery time associated with a first data packet. The method includes sending, by the communications device, the first data packet to the first transceiver device in accordance with the first delivery time, wherein the first data packet is configured to prompt the first transceiver device to transmit the first data packet to the first mobile device.

In accordance with another example embodiment of the present disclosure, a communications device adapted to send data packets to mobile devices is provided. The communications device includes a processor, and a computer readable storage medium storing programming for execution by the processor. The programming including instructions to generate time-location information for a first mobile device in accordance with mobility information for the first mobile device and other mobility-related information, wherein the time-location information comprises predictions of when coverage areas of a plurality of transceiver devices operatively coupled to the communications device cover the first mobile device, wherein the communications device serves the first mobile device, select a first transceiver device from the plurality of transceiver devices in accordance with the time-location information and a delivery time associated with a first data packet, and send the first data packet to the first transceiver device in accordance with the delivery time, wherein the first data packet is configured to prompt the first transceiver device to transmit the first data packet to the first mobile device.

In accordance with another example embodiment of the present disclosure, a method for sending data packets to mobile devices is provided. The method includes generating, by a transceiver device, first mobility information for a first mobile device, wherein the transceiver device is part of a plurality of transceiver devices, and wherein coverage areas of the plurality of transceiver devices cover the first mobile device, sending, by the transceiver device, the first mobility information to a communications device, receiving, by the transceiver device, a data packet in accordance with a delivery time associated with the data packet, wherein the transceiver device is selected from of the plurality of transceiver devices in accordance with time-location information, and wherein the time-location information is associated with the first mobility information and other mobility-related information of the first mobile device, and sending, by the transceiver device, the data packet to the first mobile device.

In accordance with another example embodiment of the present disclosure, a transceiver device adapted to send data packets to mobile devices is provided. The transceiver device includes a processor, and a computer readable storage medium storing programming for execution by the processor. The programming including instructions to generate first mobility information for a first mobile device, wherein the transceiver device is part of a plurality of transceiver devices, and wherein coverage areas of the plurality of transceiver devices cover the first mobile device, send the first mobility information to a communications device, receive a data packet in accordance with a delivery time associated with the data packet, wherein the transceiver device is selected from of the plurality of transceiver devices in accordance with time-location information, and wherein the time-location information is associated with the first mobility information and other mobility-related information of the first mobile device, and send the data packet to the first mobile device.

One advantage of an embodiment is that a low-cost systems and methods for providing connectivity in high-speed and high density environments are provided. The low implementation costs can help acceptance and deployment.

A further advantage of an embodiment is that the systems and methods can also be used in monitoring the high-speed highways, providing an additional technique for monitoring traffic flow.

Advantageous features of embodiments may include: a communications system comprising: a plurality of transceiver devices configured to deliver data packets to mobile devices; and a coordinating device operatively coupled to the plurality of transceiver devices, the coordinating device configured to generate time-location information for a first mobile device in accordance with mobility information for the first mobile device and other mobility-related information, wherein the time-location information comprises predictions of when coverage areas of the plurality of transceiver devices cover the first mobile device, to select a first transceiver device from the plurality of transceiver devices in accordance with the time-location information and a delivery time associated with a first data packet, and to send the first data packet to the first transceiver device in accordance with the delivery time, wherein the first data packet is configured to prompt the first transceiver device to transmit the first data packet to the first mobile device.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an example high-speed highway according to example embodiments described herein;

FIG. 2a illustrates a first example communications system deployed on a high-speed highway according to example embodiments described herein;

FIG. 2b illustrates a second example communications system deployed on multiple high-speed highways according to example embodiments described herein;

FIG. 3 illustrates a portion of an example communication system according to example embodiments described herein;

FIG. 4 illustrates a diagram of RSU service as a function of time according to example embodiments described herein;

FIG. 5 illustrates a flow diagram of example operations occurring in a RSC according to example embodiments described herein;

FIG. 6 illustrates a flow diagram of example operations occurring in a RSU according to example embodiments described herein;

FIG. 7 illustrates a flow diagram of example operations occurring in a backhaul according to example embodiments described herein;

FIG. 8 illustrates an example first communications device according to example embodiments described herein;

FIG. 9 illustrates an example second communications device according to example embodiments described herein;

FIG. 10 illustrates an example third communications device according to example embodiments described herein; and

FIG. 11 is a block diagram of a processing system that may be used for implementing the devices and methods disclosed herein.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the disclosure and ways to operate the disclosure, and do not limit the scope of the disclosure.

One embodiment of the disclosure relates to packet scheduling and delivery. For example, a coordinating device generates time-location information for a first subscriber in accordance with the mobility information for the first subscriber and other mobility-related information, selects a first transceiver device from a plurality of transceiver devices operatively coupled to the communications device in accordance with the time-location information, wherein the first transceiver device is configured to transmit a first data packet to the first subscriber, and sends the first data packet to the first transceiver device.

The present disclosure will be described with respect to example embodiments in a specific context, namely communications systems that use mobility information to schedule packets and deliver the packets to devices. The disclosure may be applied to standards compliant communications systems, such as those that are compliant with Third Generation Partnership Project (3GPP), GSM, IEEE 802.11, and the like, technical standards, and non-standards compliant communications systems, that use mobility information to schedule packets and deliver the scheduled packets.

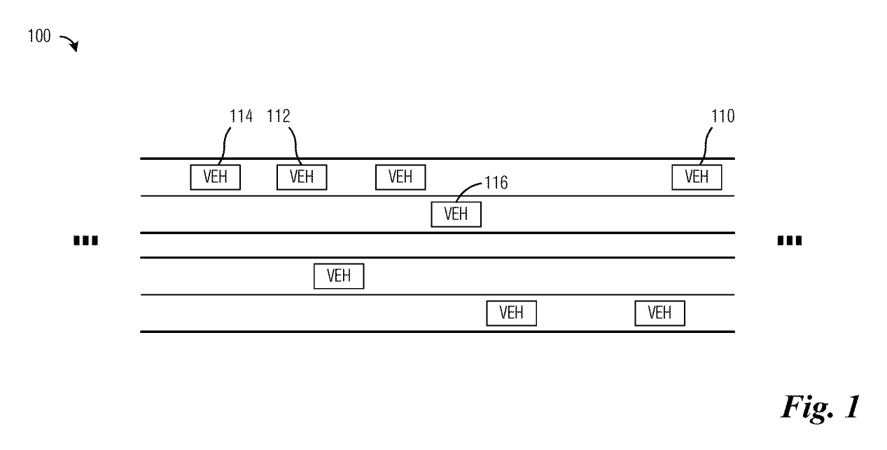

FIG. 1 illustrates an example high-speed highway 100. High-speed highway 100 may include a plurality of vehicle lanes, with each vehicle lane supporting high-speed vehicular traffic. High-speed highway 105 may be uni-directional or bi-directional. If high-speed highway 100 is a controlled access highway, then vehicles traveling thereon can enter or exit only at specific points, while vehicles travelling on a non-controlled access highway may readily enter or exit at any point.

Vehicles, such as vehicle 110, vehicle 112, vehicle 114, and vehicle 116, may travel on high-speed highway 100. In general, the mobility of the vehicles may be very predictable with the vehicles typically maintaining a substantially constant speed and heading (following the contour of the high-speed highway) except when there is an accident or when there is heavy traffic (i.e., congestion). As an example, a vehicle on high-speed highway 105 traveling at velocity V at time T is expected to be at location L at time T+X unless it has to change velocity due to congestion, accidents, and the like.

According to an example embodiment, the predictable nature of vehicular traffic (as well as other types of traffic on controlled pathways, such as rail traffic, and the like) may be exploited by systems and methods for packet scheduling and delivery to deliver packets in a timely manner. The predictable mobility of the vehicles (as well as trains, buses, and other motorized entities with predictable mobility), as well as subscribers therein, may be used to schedule and deliver packets.

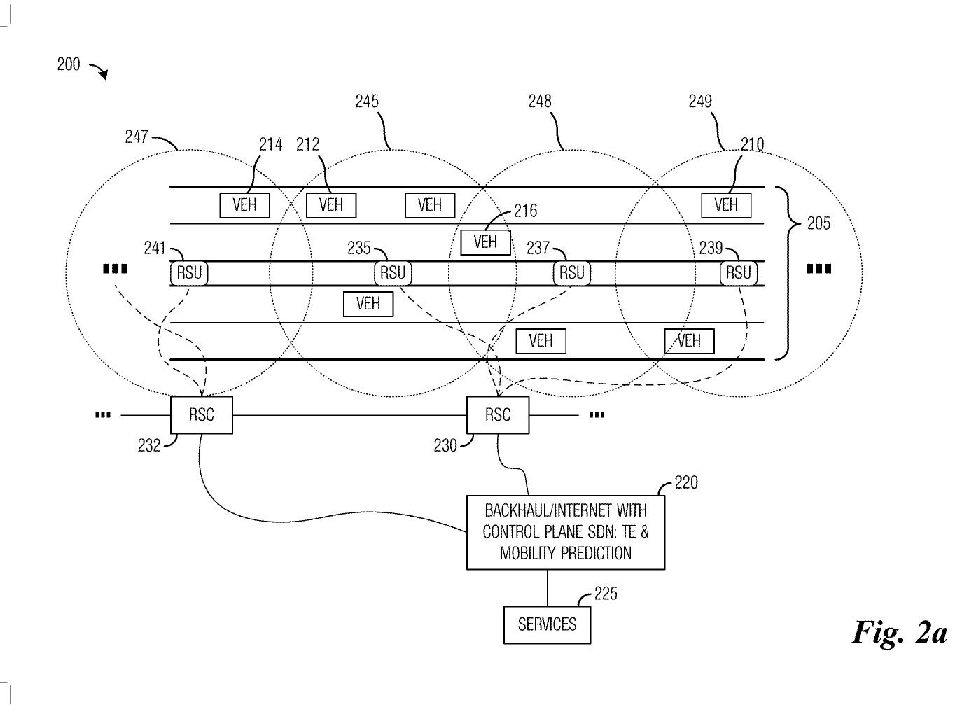

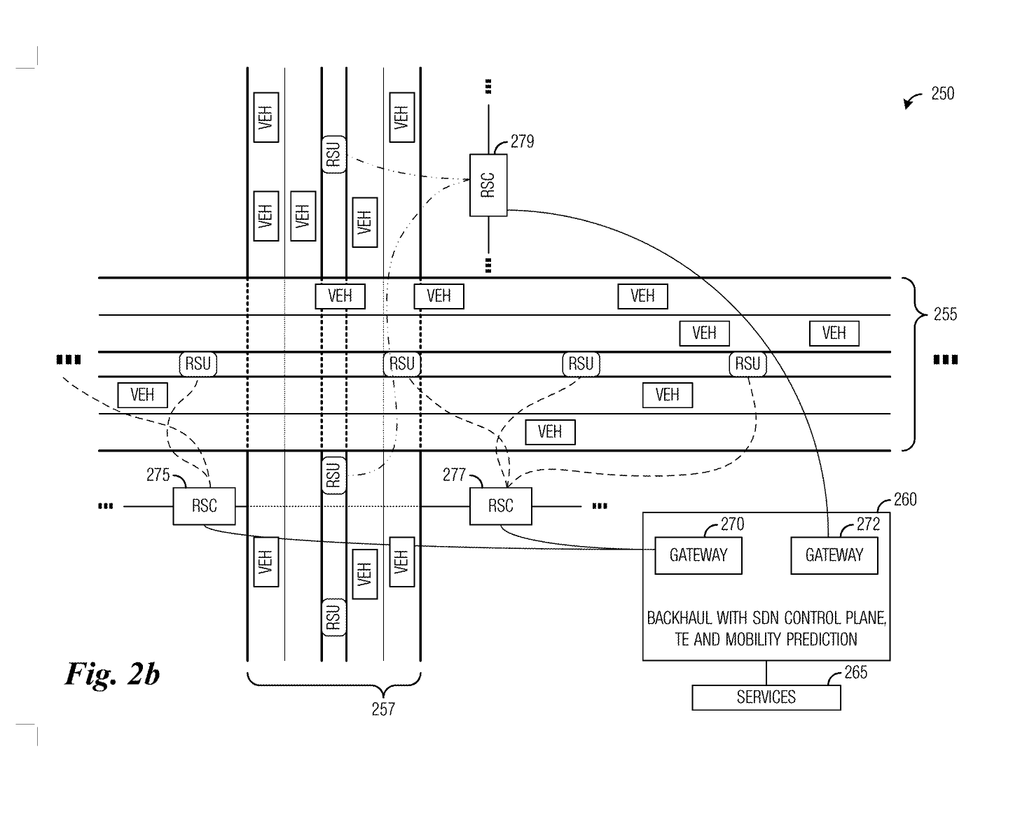

FIG. 2a illustrates a first example communications system 200 deployed on a high-speed highway 205. Although communications system 200 is discussed herein as being deployed in conjunction with a high-speed highway, example embodiments presented herein may also be deployed on rail-ways, subways, controlled access roadways, non-controlled access roadways, light-rail, and the like. Vehicles, such as vehicle 210, vehicle 212, vehicle 214, and vehicle 216, may travel on high-speed highway 205 and may be served by communications system 200. Communications system 200 may serve the vehicles, devices that are part of the vehicles, devices used by users riding in the vehicles, or a combination thereof. Vehicles, devices that are part of vehicles, devices used by users riding in vehicles, and the like, may be referred to as subscribers without loss of generality.

Communications system 200 may include a backhaul 220. Backhaul 220 may also be referred to as an internet and may include a control plane software defined network. Backhaul 220 may provide traffic engineering (TE) as well as mobility prediction for devices coupled to communications system 200. TE may be used to select a path solution (a collection of one or more paths) between a source and a destination, as well as a partitioning of a traffic flow to suit the path solution. Backhaul 220 may be connected to services 225 that provide content to subscribers coupled to communications system 200.

Backhaul 220 may be connected to road side coordinators (RSCs), such as RSC 230 and RSC 232. The RSCs may have the appearance of an access point (AP) to backhaul 220. In general, the RSCs may be responsible for sending packets received from backhaul 220 to the subscribers so that the packets arrive at a timely manner. The RSCs may also forward packets received from the subscribers to backhaul 220, where they may be provided to services 225. Each RSC may be coupled to a plurality of road side units (RSUs), such as RSC 230 being coupled to RSU 235, RSU 237, and RSU 239, while RSC 232 is coupled to RSU 241. The RSUs may be distributed antenna, remote radio heads, femtocells, picocells, and the like. The RSUs may have memory to buffer packets. It is noted that the RSCs may be coupled to other RSUs not shown in FIG. 2a. Furthermore, a single RSU may be coupled to more than one RSC.

Each RSU may have a coverage area in which it communicates with subscribers operating within its coverage area. As an illustrative example, RSU 235 may have coverage area 245 and RSU 241 may have coverage area 247. When a subscriber is in the coverage area of a RSU, the RSU may be able to transmit packets to the subscriber, as well as receive packets from the subscriber. As an example, vehicle 212 is in coverage area 245, therefore, RSU 235 may transmit packets to vehicle 212. As a vehicle moves out of the coverage area of a first RSU, it may move into the coverage area of a second RSU. The second RSU may be coupled to the same RSC as the first RSU or the second RSU may be coupled to a different RSC from the first RSU. As another example, vehicle 212 may initially be in coverage area 245 of RSU 235. However, as it continues moving, vehicle 212 may exit coverage area 245 and move into coverage area 247 of RSU 241.

The RSCs may coordinate the delivery of packets to RSUs to ensure that the packets arrive at their respective subscribers in a timely manner so that the subscribers receive continuous service without significant or unacceptable interruption. According to an example embodiment, the coordination performed by the RSCs may be based on time-location information derived from mobility information of subscribers served by the RSCs. The time-location information predicts when the subscribers will be in coverage areas of RSUs coupled to the RSCs. The mobility information may include information regarding the mobility of the subscribers, such as speed, acceleration, and the like, and may be used by the RSCs to select the RSUs that are to be used to deliver the packets to the subscribers. In addition to the mobility information of the subscribers, the time-location information may also be derived from mobility information of subscribers of other RSCs. In other words, the mobility information of subscribers not being served by a first RSC may be used by the first RSC to derive the time-location information of subscribers being served by the first RSC. Furthermore, topology information of a path used by the subscriber (e.g., topology of a highway, a railway, a subway, and the like) may be used to derive the time-location information. Also, historical information (such as known traffic patterns, accident frequency information, day of the week, holiday schedules, and the like) may be used to derive the time-location information. Additionally, topology information of the network may be used to derive the time-location information. Other examples of information that may be used to derive the time-location information include, but are not limited to: time of day, accident or incident information, weather information, position information, and the like. A further example of information that may be used to derive the time-location information may include information directly sent to the subscribers that have impact on a trajectory of the subscribers. As an illustrative example, map information derived by a mapping service based on traffic condition on a highway may provide an alternate route for a subscriber when congestion and/or an accident is detected may be used to derive the time-location information. Communications system status information may also be used to derive the time-location information. Collectively, the information used to derive the time-location information not including the mobility information of the subscribers served by a RSC may be classified as other mobility-related information.

As an illustrative example, consider subscriber A moving along high-speed highway 205 at a constant speed. The mobility information sent to the RSC provides this knowledge. The RSC may use the mobility information (as well as the other mobility-related information) to predict time-location information for subscriber A, for example: at time X, subscriber A will be in coverage area 245 of RSU 235, at time X+1 second, subscriber A will be in coverage area 248 of RSU 237, and at time X+2 second, subscriber A will be in coverage area of RSU 239. Based on the time-location information for subscriber A, the RSC may select RSU 235 to deliver packets Z through Z+L (where packet Z is the packet to be delivered at time X and L is the number of packets subscriber A will consume within 1 second), while RSU 237 will be selected to deliver packets Z+L+1 through Z+2L, and so on. The time-location information may be used as a routing table to select the RSUs.

While it is understood that communications systems may employ multiple backhauls, RSCs with a plurality of RSUs communicating with any number of vehicles, only two RSCs, four RSUs, and a plurality of vehicles are illustrated for simplicity.

FIG. 2b illustrates a second example communications system deployed on multiple high-speed highways. Although communications system 250 is discussed herein as being deployed in conjunction with high-speed highways, example embodiments presented herein may also be deployed on rail-ways, subways, controlled access roadways, non-controlled access roadways, light-rail, and the like. Vehicles may travel on a first high-speed highway 255 and a second high-speed highway 257 and may be served by communications system 250. Communications system 250 may serve the vehicles, devices that are part of the vehicles, devices used by users riding in the vehicles, or a combination thereof. Vehicles, devices that are part of vehicles, devices used by users riding in vehicles, and the like, may be referred to as subscribers without loss of generality.

Communications system 250 may include a backhaul 260. Backhaul 260 may also be referred to as an internet and may include a control plane software defined network. Backhaul 260 may provide traffic engineering (TE) as well as mobility prediction for devices coupled to communications system 250. TE may be used to select a path solution (a collection of one or more paths) between a source and a destination, as well as a partitioning of a traffic flow to suit the path solution. Backhaul 260 may be connected to services 265 that provide content to subscribers coupled to communications system 250.

Backhaul 260 may include a first gateway 270 connected to RSCs serving first high-speed highway 255, such as RSC 275 and RSC 277, and a second gateway 272 connected to RSCs serving second high-speed highway 257, such as RSC 279. In general, the RSCs may be responsible for sending packets received from backhaul 260 to the subscribers. The RSCs may also forward packets received from the subscribers to backhaul 260, where they may be provided to services 265. Each RSC may be coupled to a plurality of RSUs. The RSUs may be distributed antenna, remote radio heads, femtocells, picocells, and the like. The RSUs may have memory to buffer packets. It is noted that the RSCs may be coupled to other RSUs not shown in FIG. 2b. Furthermore, a single RSU may be coupled to more than one RSC.

According to another example embodiment, a RSU is effectively a beamform pointing to one particular RSU coverage area, where the beamform is obtained from a multiple antenna unit (e.g., an antenna array) which can cover part or all of the RSC controlled area. A simple RSU or a more complex RSU (e.g., distributed antenna, remote radio heads, femtocells, picocells, and the like) may be considered to be logically equivalent. In other words, a RSC views a simple RSU or a more complex RSU as simply a RSU. Effectively, the RSC behaves in the same manner when selecting a RSU (e.g., a simple RSU or a more complex RSU (such as a beamform) to be used for the transmission of packets, in accordance with the mobility information and the other mobility-related information. Precoding of the data packets may be performed prior to forwarding the data packets to the RSUs. The precoding (if any) may differ for different RSUs.

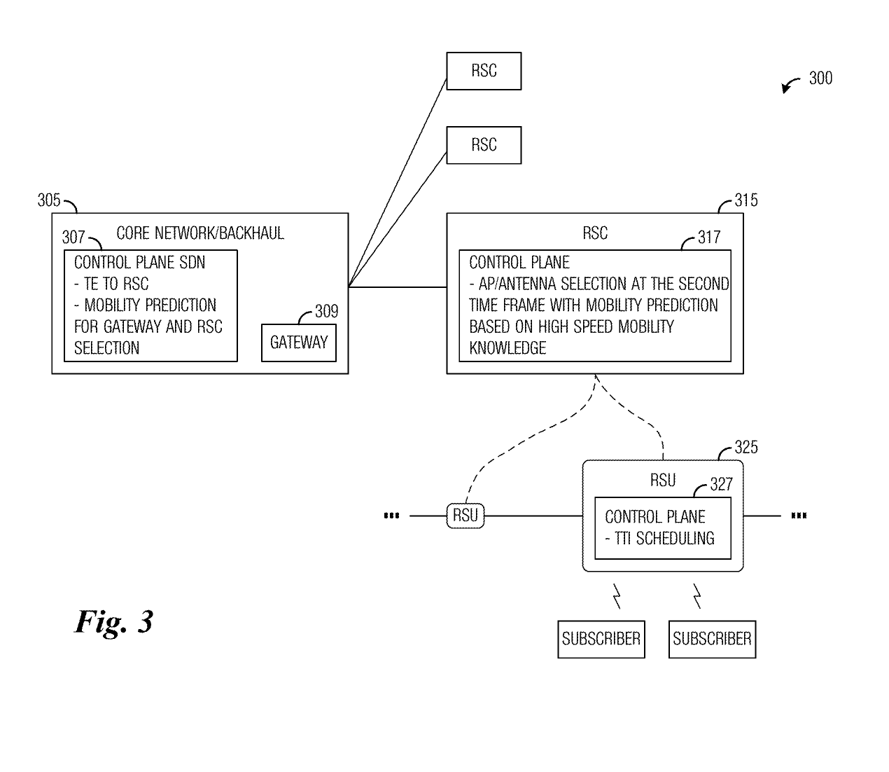

FIG. 3 illustrates a portion of an example communication system 300. Communications system 300 includes a backhaul 305. Backhaul 305 may include a core network that provides connectivity to other communications systems, content providers, service providers, and the like. Backhaul 305 may include a control plane SDN 307 that provides TE support to RSCs coupled to backhaul 305. Control plane SDN 307 may also provide mobility prediction (i.e., future location of a subscriber served by a RSC based on mobility information of the subscriber as well as other mobility-related information as described previously). The mobility prediction may be used to select RSCs to coordinate communications for subscribers. The mobility prediction may be similar to the time-location information, but may be used for RSC selection rather than RSU selection. Backhaul 305 may include a gateway 309. Gateway 309 may be an entry and/or exit for packets entering and/or exiting backhaul 305. Control plane SDN 307 may provide packets and mobility information to RSCs. In other words, the RSCs track subscribers and coordinate the delivery of packets to different RSUs to deliver the packets to the subscribers, which were provided to the RSCs by control plane SDN 307. As an illustrative example, control plane SDN 307 may provide to a RSC information such as: a subscriber is expected to enter the RSC's coverage area at time T with velocity V, data packets to deliver to the subscriber, and the like.

Backhaul 305 may be coupled to a plurality of RSCs, such as RSC 315. Other RSCs in communications system 300 that are coupled to backhaul 305 may be identical to or different from RSC 315. However, it is expected that they function in a similar manner. RSC 315 may include a control plane 317 that provides access point and/or antenna (i.e., RSUs) selection to be used to facilitate communications with subscribers. It is noted that the mobility prediction performed in a RSC may differ from mobility prediction performed by a backhaul. Mobility prediction performed in a RSC is related to the final hop of the packet in the route from service to subscriber, whereas mobility prediction performed in the backhaul is for the entirety of the route from service to subscriber. It is also noted that since RSU selection occurs at a final hop of the transmission of a packet, the change from a first RSU (used to transmit a first packet to a subscriber) to a second RSU (used to transmit a second packet to the subscriber) does not require a session change. Therefore, a session with the first RSU does not need to be torn down and then a session with the second RSU established. Each of the RSCs in communications system 300 may be coupled to a plurality of RSUs, such as RSU 325. The RSCs may be coupled to the RSUs via wireline, wireless, and/or optical links. The RSUs in communications system 300 may be identical to or different from RSU 325. When implemented as a cell, such as a femtocell or picocell, RSU 325 may include control plane 327 that provides TTI scheduling for packets transmitted to subscribers. Alternatively, RSU 325 may be implemented as an amplify and forward relay (AAF) (or a decode and forward (DAF) relay), a distributed antenna, and the like, without a control plane. The RSUs may also operate as multi-hop points, joining other RSUs for extended coverage, coverage of wide areas, and the like.

According to an example embodiment, it is possible to coordinate and/or allocate resources at a mid-level time window, as well as over a defined path supported by RSUs. Coordination may occur at a level between routing (a high level construct for determining a path between a source, such as a service, and a destination, such as a subscriber) and per transmit time interval (TTI) scheduling (a low level construct for determining which network resource, such as a time-frequency resource, a spatial resource, a code resource, a time resource, or a frequency resource, to be used to transmit a packet). According to an example embodiment, a coordinator, referred to hereinafter as a RSC, for example, may examine a combination of mobility information for a subscriber and other mobility-related information (such as network topology, mobility information of other subscribers (served by the same RSC and/or other RSCs), topology information of a physical path used by the subscriber, historical information, time of day, accident or incident information, weather information, communications system status information (such as buffer status information, arrival rates, latencies, and the like), and the like), and position information (such as location information) associated with a subscriber to determine which RSU(s) should be receiving packets intended for the subscriber, and at what time. As an illustrative example, the network topology information may be used to provide the RSC with information about which RSUs are available to service the subscribers, while the mobility information and position information about the subscribers may be used to select one or more RSUs that can provide data packets to the subscribers in timely manner. For discussion purposes, if the RSC knows that a subscriber is traveling in a specific direction along a highway, it may use network topology information to consider only RSUs that are positioned along the highway and not consider RSUs not positioned along the highway as it selects RSUs to deliver packets to the subscriber.

According to an example embodiment, in performing packet coordination, a RSC attempts to maximize the transmission of packets to subscribers as the subscribers pass through the coverage area of various RSUs, ensuring just in time delivery and minimizing collisions of data packets over the air due to RSUs cross-interference or inappropriate RSU selections that would be due to outdated mobility information of subscribers, as well as other mobility-related information. Potentially, an array of antennas, thereby allowing multiple input multiple output (MIMO) operation, may be used to minimize interference, wherein the knowledge of the data transmitted at other neighboring RSUs can be used at one RSU to apply interference cancelation and/or alignment at transmission. However, the example embodiments presented herein are operable with simple RSUs or more complex RSUs (e.g., single transmit antennas versus arrays of antennas).

As an illustrative example, referring to FIG. 2a, if a subscriber is moving at a steady rate on high-speed highway 205, RSC 230 may determine (from mobility information of the subscriber, as well as potentially from other mobility-related information) that in a first time (or first time interval), packets numbered 10-20 will be sent to RSU 239 for delivery to the subscriber, while in a second time (or second time interval), packets numbered 21-30 will be sent to RSU 237 for delivery to the subscriber, and in a third time (or third time interval), packets numbered 31-40 will be sent to RSU 235 for delivery to the subscriber, and the like. It is noted that as a subscriber continues to move, it may change RSCs. As an illustrative example, the subscriber described above may change from being served by RSC 230 to RSC 232 as it continues to move from right to left of high-speed highway 205. In such a situation, coordination between RSCs, as well as with assistance of backhaul 220, may help ensure timely delivery of packets to the subscriber.

According to an example embodiment, a RSC may examine a combination of real-time (or near real-time) mobility information (such as speed, direction, acceleration, and the like, information for a subscriber), as well as other mobility-related information to determine which RSU(s) should be receiving packets intended for the subscriber, and at what time. According to another example embodiment, a RSC may also examine other mobility-related information, such as real-time (or near real-time) mobility information and position information of other subscribers, to determine which RSU(s) should be receiving packets intended for the subscriber, and at what time. As an illustrative example, if the mobility information and position information for a first subscriber indicates that it is moving along a high-speed highway at posted speed limits, but if the mobility information and position information for a second subscriber indicates that it is immobile on the same high-speed highway one mile down the road, the RSC may be able to adjust the RSU(s) that it determines will receive packets intended for the first subscriber. According to another example embodiment, a RSC may also examine other mobility-related information, such as real-time (or near real-time) mobility information and position information of all subscribers of a sector, to determine which RSU(s) should be receiving packets intended for the subscriber, and at what time.

A sector may be representative of a section or portion of a coverage area. As an illustrative example, a coverage area may be partitioned into three sectors (of equal or different sizes). Furthermore, a sector may span one or more coverage areas.

According to an example embodiment, the RSCs maintain mobility information (real-time or near real-time), position information, and the like, for subscribers. The RSCs may share the mobility information (real-time or near real-time), the other mobility-related information, and the like, to help maintain continuous service for subscribers. According to an example embodiment, RSUs measure mobility information, the other mobility-related information, and the like, for subscribers in their respective coverage areas. The RSUs may provide the information to RSCs.

According to yet another example embodiment, the RSC may also examine other mobility-related information, such as channel or environmental information regarding communications channels (i.e., wireless links between RSUs and subscribers), to help determine which RSU(s) should be receiving packets intended for the subscriber, and at what time. As an illustrative example, if one RSU has a particularly good connection with subscribers operating in its coverage area, the coordinator may allocate more packets for the RSU since vehicles may stay within the coverage area of the RSU for an extended amount of time.

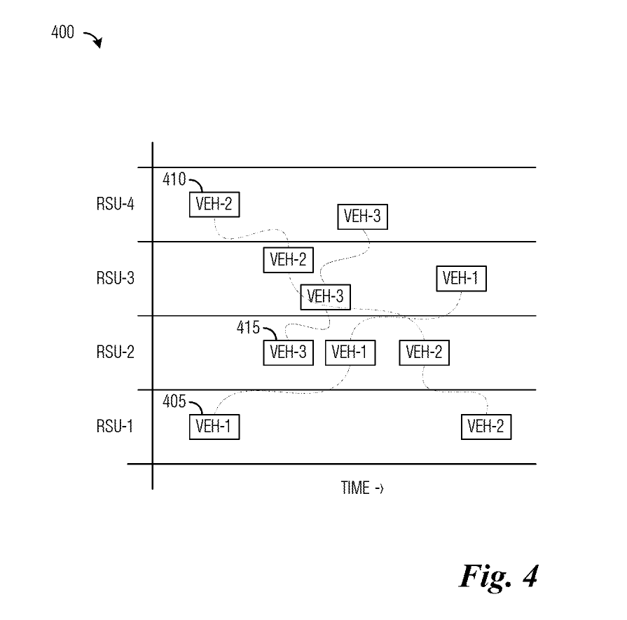

FIG. 4 illustrates a diagram 400 of RSU service as a function of time. Diagram 400 displays three vehicles (VEH-1 405, VEH-2 410, and VEH-3 415), i.e., subscribers, and RSUs serving the vehicles as the vehicles move. VEH-1 405 is initially served by RSU-1 and then RSU-2 and RSU-3, while VEH-2 410 is initially served by RSU-4, and then RSU-3, RSU-2, and RSU-1. Similarly, VEH-3 415 is initially served by RSU-2, and then RSU-3 and RSU-4. As an illustrative example, a VSC serving VEH-2 410 may select to deliver (based on the mobility information and associated predictions) a first portion of a packet stream at a first time to RSU-4, a second portion of the packet stream at a second time to RSU-3, a third portion of the packet stream at a third time to RSU-2, and a fourth portion of the packet stream at a fourth time to RSU-1.

According to an example embodiment, the RSC(s) connected to the RSUs chooses which RSU(s) (one or more) to forward packets so that the packets are at the RSU(s) when the vehicle (subscriber) is in the coverage area of the RSU(s). The RSC(s) may need to solve conflicting constraints (e.g., satisfying demand and/or fairness) while considering available resources, i.e., the RSU(s). The RSC(s) may also need to continuously track changes in mobility of the subscribers. As an illustrative example, if a subscriber changes direction, speed, lanes, and the like, a previously selected RSU(s) may no longer be correct. The RSC(s) may need to select an alternative RSU(s). The RSC(s) may need to perform this selection on the order of 100s of milliseconds or seconds. It is noted that although the RSU(s) serving a subscriber may change over time, there may be no handover between successive RSUs. However, RSU selection may not be on the level of a TTI scheduler (which may be performed by a RSU or a RSC coupled to the RSU) since TTI scheduling is at a finer time scale, and may be performed after RSU selection.

As an illustrative example, consider a situation wherein a subscriber (in a vehicle, for example) is moving at 120 km/hour down a high-speed highway. The subscriber takes approximately 15 seconds to pass through a 500 m segment. If there are 10 antennas (i.e., RSUs) per segment, the subscriber will take approximately 1.5 seconds to pass through the coverage area of each antenna. This may be a lower bound for density since autonomous vehicles would be expected to travel at higher speeds. In effect, the RSC controlling the RSUs in a segment may be conceptualized as a router which redefines routes rapidly and transparently from the remainder of the communications system and the subscribers, to accommodate subscriber mobility without actually going through a handover procedure. The RSC may be considered to be an access point. The RSC (in the case of RSUs being simple antennas) or the RSU (in the case of the RSUs being cells) may perform actual scheduling of packets to resource blocks at the TTI level. In other words, the packet flow may be split in time and space and pushed to the RSUs to make the packets in the packet flow available to the subscribers when they are in reach. The RSC may be performing the splitting of the packet flow.

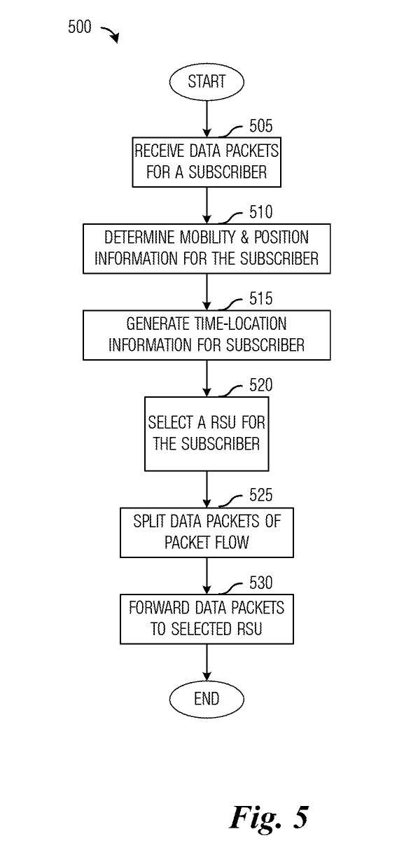

FIG. 5 illustrates a flow diagram of example operations 500 occurring in a RSC. Operations 500 may be indicative of operations occurring in a RSC, such as RSC 230 and RSC 232.

Operations 500 may begin with the RSC receiving data packets of a packet flow for a subscriber (block 505). The RSC may receive a portion of the data packets of the packet flow or the RSC may receive an entirety of the data packets of the packet flow. As an illustrative example, the RSC may receive a portion of the data packets of the packet flow for a duration that the subscriber is expected to remain within a coverage area of the RSUs controlled by the RSC. The RSC may determine mobility information, as well as position information, for the subscriber (block 510). The RSC may receive the information (or a portion thereof) (the mobility information and the position information) from RSUs connected to the RSC. The RSC may receive the information (or a portion thereof) from other RSCs. The RSC may receive the information (or a portion thereof) from the backhaul and/or core network. The RSC may also derive the information (or a portion thereof) from image data, video data, Doppler data, and the like.

The RSC may generate time-location information for the subscriber (block 515). As previously discussed, the time-location information may provide expected locations of the subscriber at various times as the subscriber continues to move through the coverage area of the RSUs controlled by the RSC. The time-location information may be generated based on the mobility information and the position information for the subscriber provided by the RSUs, as well as other mobility-related information. The other mobility-related information may include mobility information and position information of other subscribers. The other mobility-related information may also include historical information. Further examples of the other mobility-related information may include topology information of a path used by the subscriber, topology information of the network, time of day, accident or incident information, weather information, position information, communications system status information, and the like. The time-location information may also be generated from some forms of data sent to the subscriber. As an illustrative example, if the subscriber is moving at a constant speed and other subscribers in the general area are also moving at a constant speed, the RSC may readily predict that the subscriber will maintain its constant speed and generate the time-location information accordingly. As another illustrative example, if the subscriber is moving at a constant speed, but mobility information for other subscribers show that 1 mile down the road, all traffic has stopped, the RSC may predict that the subscriber will soon begin to slow down and subsequently come to a complete stop and generate the time-location information accordingly. As yet another illustrative example, if the subscriber is moving at a constant speed at 5 pm on a weekday, but historical information shows that with 95% probability there will be severe traffic congestion 1 mile down the highway, the RSC may predict that the subscriber will soon begin to slow down and generate the time-location information accordingly.

The RSC may select one or more RSUs to deliver data packets to the subscriber based on the time-location information and delivery times associated with the data packets (block 520). The selection of the one or more RSUs may be based on the time-location information of the subscriber and the delivery times associated with the data packets to be delivered to the subscriber. As an illustrative example, if the time-location information of the subscriber predicts that at time X, the subscriber will be served RSU 1 and at time Z, the subscriber will be served by RSU 2, then for data packets to be delivered at time X, the RSC may select RSU 1 and for data packets to be delivered at time Z, the RSC may select RSU 2. The selection of the one or more RSUs may also be based on data traffic requirements of the subscriber as well as data traffic requirements of other subscribers. As an illustrative example, if the QoS requirements of a first subscriber are tight with low delay being tolerable and the QoS requirements of a second subscriber are low with high delay being tolerable, the RSC may give selecting RSUs for the first subscriber higher priority than selecting RSUs for the second subscriber. Continuing with the example, if RSU1 is heavily loaded and RSU2 further down the highway is lightly loaded, due to the first subscriber's tight QoS requirements and low tolerance for delay, the RSC may select RSU1 at a first time only for the first subscriber while selecting RSU2 at a second time for both subscribers.

As an illustrative example, consider a first data packet and a second data packet that are to be delivered to a subscriber. The RSC may select a first RSU to transmit the first data packet to the subscriber. The selection of the first RSU may be in accordance with the time-location information and a first delivery time associated with the first data packet. The RSC may select a second RSU to transmit the second data packet to the subscriber. The selection of the second RSU may be in accordance with the time-location information and a second delivery time associated with the second data packet. The RSC may forward the first data packet and the second data packet to the respective first and second RSUs in accordance with the first delivery time and the second delivery time. The first data packet and the second data packet may be part of a single packet flow. Alternatively, the first data packet and the second data packet are parts of different packet flows.

The selection of the one or more RSUs may be temporal in nature, meaning that the RSUs are not permanently selected. Instead, the RSUs are selected for only a time when the subscriber is predicted to be within their respective coverage areas. As an example, a first RSU may be selected for only a first duration, a second RSU may be selected for only a second duration, and the like. The selection of the one or more RSUs may also be based on channel or environmental information regarding communications channels, buffer status, packet rates, and the like. The RSC may split the data packets of the packet flow (block 525). The RSC may split the data packets of the packet flow based on the one or more RSUs that it selected. As an illustrative example, the RSC may have selected 4 RSUs to deliver the data packets to the subscriber. The RSC may split the data packets into 4 portions, with a first portion being assigned to a first selected RSU, a second portion being assigned to a second selected RSU, and so on. The RSC may forward the split data packets to the one or more RSUs selected (block 530). The RSC may forward the data packets to the RSUs in accordance with the delivery time of the data packets. As an illustrative example, the RSC may forward the data packets at a time substantially equal to the delivery time of the data packets. As another illustrative example, the RSC may forward the data packets at a time a small amount of time prior to the delivery time of the data packets to account for network latency. As yet another illustrative example, the RSC may forward the data packets at a time significantly prior to the delivery time of the data packets, allowing the RSUs to process the data packets if needed and/or to buffer the data packets. It is noted that the RSC may send the data packets to different RSUs at different times. As an illustrative example, the RSC may send data packets for a first RSU at a time substantially equal to the delivery time for the data packets, while data packets for a second RSU may be sent at a time slightly prior to the delivery time of the data packets and data packets for a third RSU may be sent at a time significantly prior to the delivery time for the data packets. The illustrative example is intended for discussion purposes and that other examples are possible.

If beamforming is used at the RSUs, the RSC may precode the data packets in accordance with the RSUs selected prior to forwarding the split data packets to the one or more RSUs selected. Alternatively, the RSUs may perform the precoding of the data packets.

The RSC may forward the split data packets to the one or more RSUs all at once (or substantially at once). The RSC may forward the split data packets to the one or more RSU in a sequential manner, where the first selected RSU is delivered the first portion, then the second selected RSU is delivered the second portion, and so forth. The RSC may forward the data packets to the RSUs to ensure that the data packets are delivered to the RSUs in timely manner.

A hybrid automatic repeat requested (HARQ) process may be used to detect and/or recover from failed delivery of a data packet(s). A HARQ process on a subscriber may send an acknowledgment or negative acknowledgement corresponding to a successful or unsuccessful delivery and decode of a data packet(s). The HARQ process may also send a negative acknowledgement corresponding to an absence of an expected data packet(s). It is noted that an unsuccessful data packet delivery may be due to a bad transmission due to poor channel condition and not from an error in mobility knowledge. In such a situation, the RSUs or RSC may attempt to retransmit the data packet.

At the RSC, a negative acknowledgement may cause the RSC to reevaluate the mobility information, the position information, the time-location information, as well as the other mobility-related information. As an illustrative example, the RSC may request updates to the mobility information, the position information, and/or the other mobility-related information, and based on the updates, regenerate the time-location information. The regenerated time-location information may be used to reselect one or more RSUs to deliver the data packets to the subscriber (referred to herein as newly selected RSUs, as opposed to previously selected RSUs). If the newly selected RSUs are different from the previously selected RSUs, the RSC may inform the previously selected RSUs to forward the data packets to the newly selected RSUs. Alternatively, if the RSC buffered the data packets prior to sending them to the RSUs, the RSCs may simply forward appropriate data packets to the newly selected RSUs. In such a scenario, the RSC may inform the previously selected RSUs to discard the data packets.

According to an example embodiment, the mobility information of the subscribers may also be used to detect a mobility condition of the mobility infrastructure used by the subscribers. The mobility condition may trigger action(s) by providers of the mobility infrastructure. As an example, if the subscribers are in automobiles, the speed of the subscribers may be used to detect the presence and location of traffic congestion, accidents, impaired operators, faulty equipment, and the like. The presence and location of the congestion, accidents, and the like, may be provided to emergency authorities, who may then investigate and help to clear up the incident, for example. Furthermore, information related to the incident may be provided to subscribers via road signs, messages, and the like, to help avoid escalating the severity of the incident by providing alternative routes, for instance.

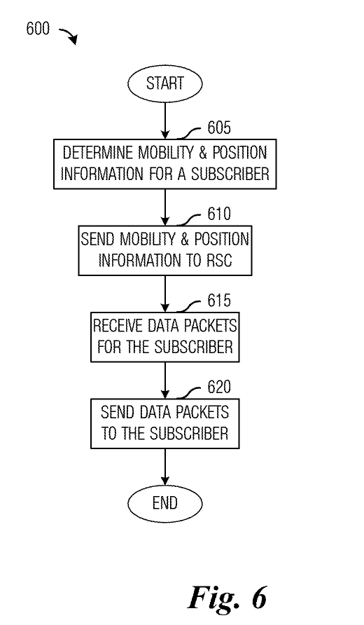

FIG. 6 illustrates a flow diagram of example operations 600 occurring in a RSU. Operations 600 may be indicative of operations occurring in a RSU, such as RSU 235, RSU 237, RSU 239, and RSU 241.

Operations 600 may begin with the RSU determining mobility information, as well as position information for a subscriber (block 605). The subscriber may already be within the coverage area of the RSU. The subscriber may be coming within the coverage area of the RSU within a specified amount of time. The RSU may measure the mobility information and the position information. The RSU may measure the information (the mobility information and the position information) based on measurements of signals received from the subscriber (e.g., Doppler measurements allowing the RSC to infer position and speed from multiple RSU's Doppler reports). The RSU may receive the information transmitted by the subscriber, such as from global positioning system (GPS) information, and the like. The RSU may also have video cameras that are directed along the directions of traffic flow, for example, capturing image data of vehicles and/or subscribers. The vehicles and/or subscribers may be identified using their license plates, visual tags (such as bar codes, identifying labels, and the like), and so on. The RSU may analyze the image data to derive the information (the mobility information and the position information). The RSU may also be connected to sensors deployed along the road, in the road, over the road, and the like, to obtain and derive the information. The RSU may receive the information from other RSUs that have previously serviced the subscriber. The RSU may send the information to a RSC controlling the RSU (block 610). The RSU may report the information (the mobility information and the position information) to the RSC. The RSU may also report the information to other RSCs, such as nearby or neighboring RSCs. According to an example embodiment, in a situation where multiple subscribers are in close proximity (e.g., multiple subscribers are in a single vehicle, such as a van, bus, train car, and the like), the RSU may report information for one subscriber instead of reporting information for each subscriber, thereby reducing communications overhead. Alternatively, the RSU may report information for a subset of the subscribers instead of reporting information for all subscribers. The RSU may receive data packets to be delivered to the subscriber (block 615). In a situation wherein the RSU reported information for multiple subscribers that are in close proximity, the RSU may still receive separate data for each of the subscribers. The RSU may deliver the data packets to the subscriber (block 620). The RSU may schedule the data packets for transmission over resource blocks to the subscriber.

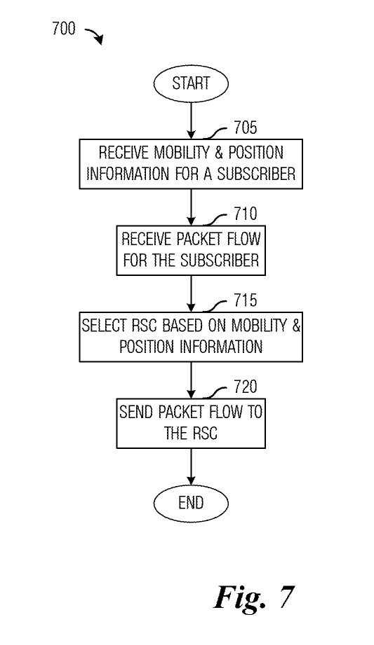

FIG. 7 illustrates a flow diagram of example operations 700 occurring in a backhaul. Operations 700 may be indicative of operations occurring in a backhaul, such as backhaul 220.

Operations 700 may begin with the backhaul receiving mobility information, as well as position information for a subscriber (block 705). The backhaul may receive the information (the mobility information and the position information, as well as the other mobility-related information) from RSCs coupled to the backhaul. The backhaul may receive a packet flow for the subscriber (block 710). The backhaul may select a RSC to service the subscriber and the packet flow based on the information (block 715). As an example, the backhaul may select a RSC that is controlling a RSU with a coverage area within which the subscriber is located (or will soon be located). The backhaul may select a plurality of RSCs if the subscriber is highly mobile and/or if the packet flow is longer than an amount of time that the subscriber is expected to be served by the RSC. The backhaul may send the packet flow to the RSC (or the plurality of RSCs) (block 720). If the backhaul selected a plurality of RSCs, the backhaul may partition the packet flow into an appropriate number of portions and send the portions to corresponding RSCs.

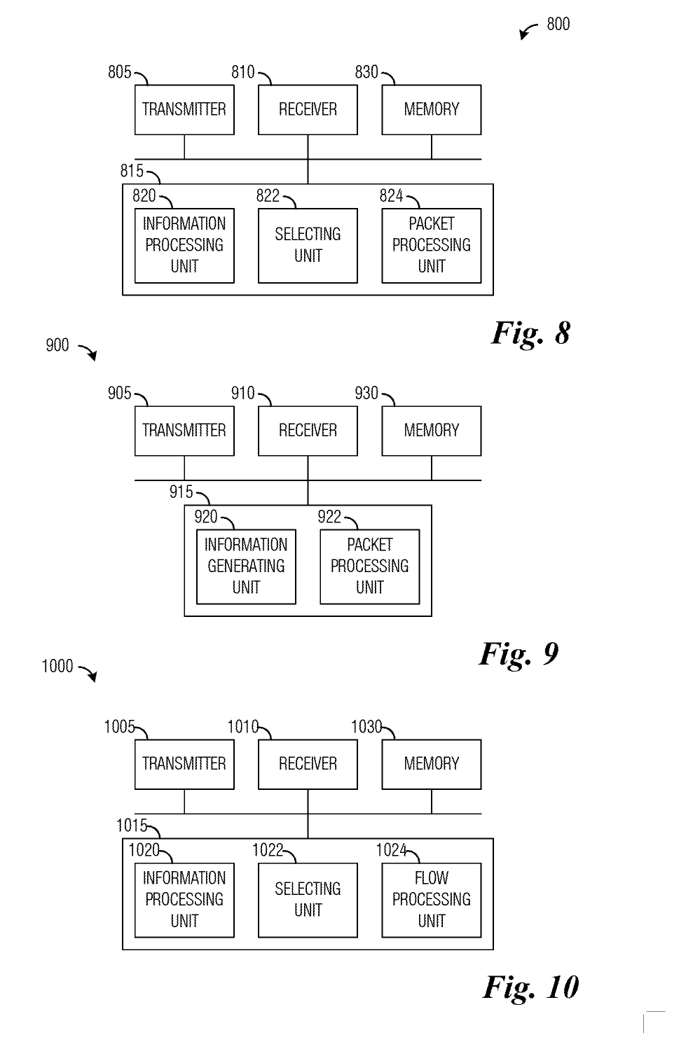

FIG. 8 illustrates an example first communications device 800. Communications device 800 may be an implementation of a RSC. Communications device 800 may be used to implement various ones of the embodiments discussed herein. As shown in FIG. 8, a transmitter 805 is configured to transmit data packets, mobility information, position information, topology information, channel condition information, communications system status information, and the like. Communications device 800 also includes a receiver 810 that is configured to receive data packets, mobility information, position information, topology information, channel condition information, communications system status information, and the like.

An information processing unit 820 is configured to process information, such as mobility information, and other mobility-related information, such as position information, topology information, channel condition information, communications system status information, some forms of data being sent to the subscribers, and the like, to generate (e.g., predict) time-location information. A selecting unit 822 is configured to select one or more RSUs coupled to communications device 800 based on output of information processing unit 820, i.e., time-location information. Selecting unit 822 is configured to select one or more RSUs coupled to communications device based on delivery time of data packets. Selecting unit 822 is configured to select one or more RSUs coupled to communications device 800 based on data traffic requirements of subscribers. A packet processing unit 824 is configured to partition packet flows based on the one or more RSUs selected by selecting unit 822 for delivery to the one or more RSUs. Packet processing unit 824 is configured to precode the data packets in situations where beamforming is used at the RSUs. Memory 830 is configured to store mobility information, other mobility-related information, such as position information, topology information, channel condition information, communications system status information, and the like, data packets, packet flows, selected RSUs, and the like.

The elements of communications device 800 may be implemented as specific hardware logic blocks. In an alternative, the elements of communications device 800 may be implemented as software executing in a processor, controller, application specific integrated circuit, or so on. In yet another alternative, the elements of communications device 800 may be implemented as a combination of software and/or hardware.

As an example, receiver 810 and transmitter 805 may be implemented as a specific hardware block, while information processing unit 820, selecting unit 822, and packet processing unit 824 may be software modules executing in a microprocessor (such as processor 815) or a custom circuit or a custom compiled logic array of a field programmable logic array. Information processing unit 820, selecting unit 822, and packet processing unit 824 may be modules stored in memory 830.

FIG. 9 illustrates an example second communications device 900. Communications device 800 may be an implementation of a RSU. Communications device 900 may be used to implement various ones of the embodiments discussed herein. As shown in FIG. 9, a transmitter 905 is configured to transmit data packets, mobility information, position information, topology information, channel condition information, communications system status information, and the like. Communications device 900 also includes a receiver 910 that is configured to receive data packets, mobility information, position information, topology information, channel condition information, communications system status information, and the like.

An information generating unit 920 is configured to generate information, such as mobility information, and other mobility-related information, such as position information, topology information, channel condition information, communications system status information, and the like. The information generated may be reported to a RSC controlling communications device 900. A packet processing unit 922 is configured to receive data packets intended for subscribers and perform processing that may be needed to deliver them to their respected subscribers. Memory 930 is configured to store information, position information, topology information, channel condition information, communications system status information, data packets, and the like.

The elements of communications device 900 may be implemented as specific hardware logic blocks. In an alternative, the elements of communications device 900 may be implemented as software executing in a processor, controller, application specific integrated circuit, or so on. In yet another alternative, the elements of communications device 900 may be implemented as a combination of software and/or hardware.

As an example, receiver 910 and transmitter 905 may be implemented as a specific hardware block, while information generating unit 920, and packet processing unit 922 may be software modules executing in a microprocessor (such as processor 915) or a custom circuit or a custom compiled logic array of a field programmable logic array. Information generating unit 920, and packet processing unit 922 may be modules stored in memory 930.

FIG. 10 illustrates an example third communications device 1000. Communications device 1000 may be an implementation of a backhaul gateway. Communications device 1000 may be used to implement various ones of the embodiments discussed herein. As shown in FIG. 10, a transmitter 1005 is configured to transmit data packets, mobility information, position information, topology information, channel condition information, communications system status information, and the like. Communications device 1000 also includes a receiver 1010 that is configured to receive data packets, mobility information, position information, topology information, channel condition information, communications system status information, and the like.

An information processing unit 1020 is configured to process information, such as mobility information, position information, topology information, channel condition information, communications system status information, and the like. A selecting unit 1022 is configured to select one or more RSCs coupled to communications device 1000 based on output of information processing unit 1020, i.e., mobility information, position information, topology information, channel condition information, communications system status information, and the like. A flow processing unit 1024 is configured to partition packet flows based on the one or more RSCs selected by selecting unit 1022 for delivery to the one or more RSCs. Memory 1030 is configured to store information, position information, topology information, channel condition information, communications system status information, data packets, packet flows, selected RSCs, and the like.

The elements of communications device 1000 may be implemented as specific hardware logic blocks. In an alternative, the elements of communications device 1000 may be implemented as software executing in a processor, controller, application specific integrated circuit, or so on. In yet another alternative, the elements of communications device 1000 may be implemented as a combination of software and/or hardware.

As an example, receiver 1010 and transmitter 1005 may be implemented as a specific hardware block, while information processing unit 1020, selecting unit 1022, and flow processing unit 1024 may be software modules executing in a microprocessor (such as processor 1015) or a custom circuit or a custom compiled logic array of a field programmable logic array. Information processing unit 1020, selecting unit 1022, and flow processing unit 1024 may be modules stored in memory 1030.

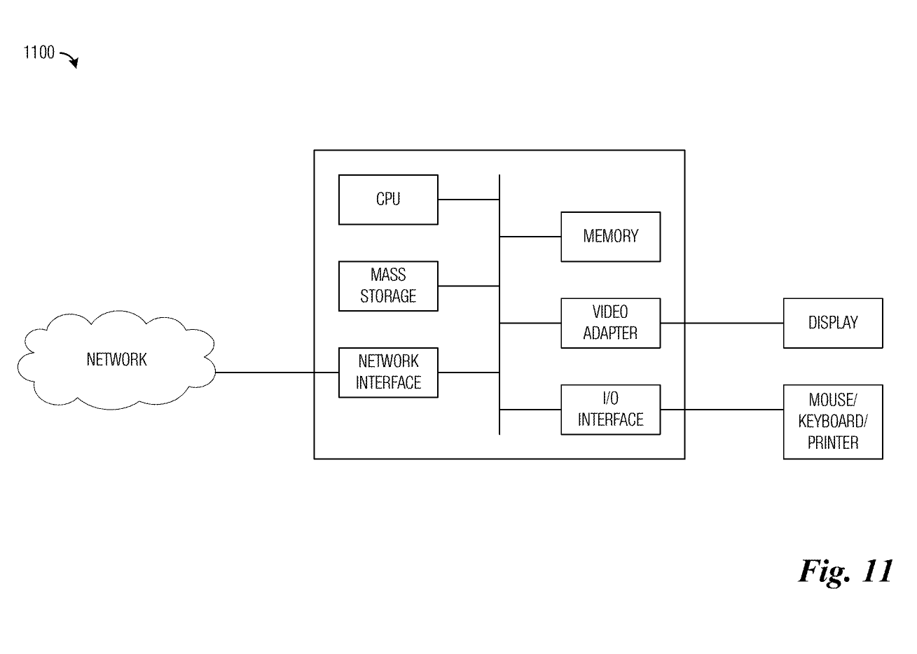

FIG. 11 is a block diagram of a processing system 1100 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input/output devices, such as a speaker, microphone, mouse, touchscreen, keypad, keyboard, printer, display, and the like. The processing unit may include a central processing unit (CPU), memory, a mass storage device, a video adapter, and an I/O interface connected to a bus.

The bus may be one or more of any type of several bus architectures including a memory bus or memory controller, a peripheral bus, video bus, or the like. The CPU may comprise any type of electronic data processor. The memory may comprise any type of system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

The mass storage device may comprise any type of storage device configured to store data, programs, and other information and to make the data, programs, and other information accessible via the bus. The mass storage device may comprise, for example, one or more of a solid state drive, hard disk drive, a magnetic disk drive, an optical disk drive, or the like.

The video adapter and the I/O interface provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface such as Universal Serial Bus (USB) (not shown) may be used to provide an interface for a printer.

The processing unit also includes one or more network interfaces, which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

Although the present disclosure and its advantages have been described in detail, it should be understood that various changes, substitutions and alterations can be made herein without departing from the spirit and scope of the disclosure as defined by the appended claims.

What is claimed is:

1. A method for sending data packets to mobile devices, the method comprising:
generating, by a communications device, time-location information for a first mobile device in accordance with mobility information for the first mobile device and other mobility-related information, wherein the time-location information comprises predictions of when coverage areas of a plurality of transceiver devices operatively coupled to the communications device cover the first mobile device, wherein the communication device serves the first mobile device;
selecting, by the communications device, a first transceiver device from the plurality of transceiver devices in accordance with the time-location information and a first delivery time associated with a first data packet; and
sending, by the communications device, the first data packet to the first transceiver device in accordance with the first delivery time, wherein the first data packet is configured to prompt the first transceiver device to transmit the first data packet to the first mobile device.

2. The method of claim 1, further comprising selecting the first transceiver device in accordance with data traffic requirements of at least one of the first mobile device and other mobile devices.

3. The method of claim 1, wherein the mobility information comprises real-time motion information of the first mobile device and position information of the first mobile device.

4. The method of claim 1, wherein the other mobility-related information comprises at least one of mobility information about a second mobile device also served by the communications device, mobility information about a third mobile device not served by the communications device, topology information of a path followed by the first mobile device, historical information about the path followed by the first mobile device, topology information of a communications system including the communications device and the first transceiver device, status information of the communications system, time of day, accident information, incident information, alternative routing data being sent to the first mobile device, and weather information.

5. The method of claim 1, wherein the time-location information comprises predicted positions of the first mobile device at specific times.

6. The method of claim 1, wherein the mobility information is derived from one or more of the following: signaling received from at least one transceiver device in the plurality of transceiver devices; signaling from the first transceiver device; and image data including the first mobile device.

7. The method of claim 1, further comprising determining a mobility condition experienced by the first mobile device in accordance with the mobility information and the other mobility-related information.

8. The method of claim 1, further comprising:
selecting a second transceiver device from the plurality of transceiver devices to transmit a second data packet to the first mobile device, wherein the second transceiver device is selected in accordance with the time-location information and a second delivery time associated with the second data packet, and wherein the second transceiver device is configured to transmit the second data packet to the first mobile device; and
sending the second data packet to the second transceiver device in accordance with the second delivery time, wherein the second data packet is configured to prompt the second transceiver device to transmit the second data packet to the first mobile device.

9. The method of claim 8, wherein the first data packet and the second data packet are part of a single packet flow.

10. The method of claim 1, wherein mobility information includes information for a second mobile device that is in motion along with the first mobile device.

11. A communications device adapted to send data packets to mobile devices, the communications device comprising:
a processor; and
a computer readable storage medium storing programming for execution by the processor, the programming including instructions to:
generate time-location information for a first mobile device in accordance with mobility information for the first mobile device and other mobility-related information, wherein the time-location information comprises predictions of when coverage areas of a plurality of transceiver devices operatively coupled to the communications device cover the first mobile device, wherein the communications device serves the first mobile device,
select a first transceiver device from the plurality of transceiver devices in accordance with the time-location information and a delivery time associated with a first data packet, and
send the first data packet to the first transceiver device in accordance with the delivery time, wherein the first data packet is configured to prompt the first transceiver device to transmit the first data packet to the first mobile device.

12. The communications device of claim 11, wherein the programming includes instructions to select the first transceiver device in accordance with data traffic requirements of at least one of the first mobile device and other mobile devices.

13. The communications device of claim 11, wherein the programming includes instructions to derive the mobility information from at least one of signaling received from at least one transceiver device in the plurality of transceiver devices, signaling from the first transceiver device, and image data including the first mobile device.

14. The communications device of claim 11, wherein the programming includes instructions to select a second transceiver device from the plurality of transceiver devices to transmit a second data packet to the first mobile device, wherein the second transceiver device is selected in accordance with the time-location information and a second delivery time associated with the second data packet, and wherein the second transceiver device is configured to transmit the second data packet to the first mobile device, and send the second data packet to the second transceiver device in accordance with the second delivery time, wherein the second data packet is configured to prompt the second transceiver device to transmit the second data packet to the first mobile device.

15. A method for sending data packets to mobile devices, the method comprising:
generating, by a transceiver device, first mobility information for a first mobile device, wherein the transceiver device is part of a plurality of transceiver devices, and wherein coverage areas of the plurality of transceiver devices cover the first mobile device;
sending, by the transceiver device, the first mobility information to a communications device;
receiving, by the transceiver device, a data packet in accordance with a delivery time associated with the data packet, wherein the transceiver device is selected from of the plurality of transceiver devices in accordance with time-location information, and wherein the time-location information is associated with the first mobility information and other mobility-related information of the first mobile device; and
sending, by the transceiver device, the data packet to the first mobile device.

16. The method of claim 15, wherein generating the first mobility information comprises:
determining real-time motion information of the first mobile device;
determining position information of the first mobile device; and
generating the first mobility information in accordance with the real-time motion information and the position information.

17. The method of claim 15, further comprising:
generating second mobility information for a second mobile device; and
sending the first mobility information to the communications device.

18. A transceiver device adapted to send data packets to mobile devices, the transceiver device comprising:
a processor; and
a computer readable storage medium storing programming for execution by the processor, the programming including instructions to:
generate first mobility information for a first mobile device, wherein the transceiver device is part of a plurality of transceiver devices, and wherein coverage areas of the plurality of transceiver devices cover the first mobile device,
send the first mobility information to a communications device,
receive a data packet in accordance with a delivery time associated with the data packet, wherein the transceiver device is selected from of the plurality of transceiver devices in accordance with time-location information, and wherein the time-location information is associated with the first mobility information and other mobility-related information of the first mobile device, and
send the data packet to the first mobile device.

19. The transceiver device of claim 18, wherein the programming includes instructions to determine real-time motion information of the first mobile device, determine position information of the first mobile device, and generate the first mobility information in accordance with the real-time motion information and the position information.

20. The transceiver device of claim 18, wherein the programming includes instructions to generate second mobility information for a second mobile device, and send the first mobility information to a second communications device.
